(19) United States
(12) Patent Application Publication
(10) Pub. No.: US 2006/0196929 A1
(43) Pub. Date: Sep. 7, 2006

(54) MULTIPLE USE SECURE TRANSACTION CARD

(75) Inventors: Edward E. Kelley, Wappingers Falls, NY (US); Franco Motika, Hopewell Junction, NY (US)

Correspondence Address: WHITHAM, CURTIS & CHRISTOFFERSON, P.C., 11491 SUNSET HILLS ROAD, SUITE 340, RESTON, VA, 20190, US

(73) Assignee: INTERNATIONAL BUSINESS MACHINES CORPORATION, Armonk, NY (US)

(21) Appl. No.: 10/906,692

(22) Filed: Mar. 2, 2005

(51) Int. Cl. G06K 5/00; G06K 19/06

(52) U.S. Cl. 235/380; 235/492

(57) ABSTRACT

Diverse and or multiple functions are performed in a secure manner using a secure transaction card which validates a holder of the secure transaction card in accordance with a Personal Identification Number (PIN), generates, encrypts and transmits a pair of pseudo-random number sequences through a card reader to validate the card and generates, encrypts and transmits control signals or other information corresponding to a function comprising at least one of personal identity data, passport data, equipment control signals, an entry request to a secure area, medical records or access data therefor, note pad access data and secure telephone entry data in accordance with a protocol suitable for each function. One or more such functions can thus be performed in a secure manner from a single secure transaction card and selection, if needed, can be performed by a menu included in the secure transaction card.

### BACKGROUND OF THE INVENTION

1. Field of the Invention

The present invention generally relates to so-called smart cards and, more particularly to alternative uses of highly secure credit cards as personal identification cards for controlling access to data, secured locations, machinery, personal or commercial articles, data processing equipment and the like.

2. Description of the Prior Art

Proliferation of fraudulent activities such as identity theft, often facilitated by streamlining of electronic financial transactions and the proliferation of credit and debit cards often used in such transactions, has led to great interest in techniques for improving security and authentication on the identity of a user of such credit and debit cards. Recent advances in semiconductor technology has also allowed chips to be fabricated with substantial flexibility and robustness adequate for inclusion of electronic circuits of substantial complexity within conveniently carried cards similar to credit cards. Such technology has also allowed records of substantial information content to be similarly packaged and associated with various articles, animals or persons such as maintenance records for motor vehicles or medical records for humans or animals. In regard to increase of security for financial transactions however, various attempts to increase security through improved identity authentication or disablement in case of theft or other misuse, while large in number and frequently proposed have not, until recently, proven adequate for the purpose.

However, a highly secure credit or debit card design has been recently invented and is disclosed in U.S. Pat. No. 6,641,050 B2, issued Nov. 4, 2003, and assigned to the assignee of the present invention. The entire disclosure of this U.S. patent is hereby fully incorporated by reference for details of implementation thereof. In summary, the secure credit/debit card disclosed therein includes a keyboard or other selective data entry device, a free-running oscillator, an array of electronic fuses (e-fuses), a processor, a pair of linear feedback shift registers (LFSRs) and a transmitter/receiver to allow communication with an external card reader. The card is uniquely identified by a unique identification number and the programming of e-fuses which control feedback connections for each of the LFSRs, one of which is used as a reference and the other is used in the manner of a pseudo-random number generator. The card is activated only for short periods of time sufficient to complete a transaction by entry of a personal identification number (PIN) that can also be permanently programmed into the card. When the card is activated and read by a card reader, the two sequences of numbers generated by the LFSRs are synchronously generated and a portion thereof is communicated to a reader which not only authenticates the number sequences against each other and the card identification number but also rejects the portion of the sequence if it is the same portion used in a previous transaction to guard against capture of the sequences by another device. This system provides combined authentication of the user and the card, itself, which renders the card useless if lost or stolen while providing highly effective protection against simulation and/or duplication of the card and has proven highly effective in use.

However numerous and ubiquitous credit and debit card transactions may be at the present time, many other circumstances exist at the present time where increased levels of security are needed. As with credit/debit cards in the past, few efforts to provide adequate or desired levels of security have met with adequate success. For example, for data processing equipment and databases, passwords can be detected, guessed or stolen or circumvented by so-called hacking and electronic transducers or magnetic or optical devices used as keys to secure spaces, critical equipment, databases or the like can be similarly stolen or simulated. Further, the proliferation of attempts to secure disparate types of resources is causing substantial user inconvenience and, to a degree, compromising security in view of the increased difficulty of adequately protecting increased numbers of security arrangements, not the least of which is the number of different devices which must be carried by a person for access to even a modest number of common devices or locations and other transactions.

### SUMMARY OF THE INVENTION

It is therefore an object of the present invention to provide a single, highly secure device capable of providing one or more functions where security may be desirable.

In order to accomplish these and other objects of the invention, a secure transaction card is provided comprising a card body including a processor and associated storage for a stored program for operation of said processor, a communication interface, and a data entry means, a non-volatile memory for storage of identification information for said secure transaction card and a personal identification number (PIN) of a holder of said secure transaction card, and an encryption arrangement for encoding transaction information and secure control codes corresponding to a secure control function or communication of information from the secure transaction card in accordance with a protocol corresponding to the secure control function in accordance with signals stored in said non-volatile memory.

In accordance with another aspect of the invention, a method of performing a secure control function using a secure transaction card is provided comprising steps of authenticating a user of the secure transaction card using a PIN, generating a pseudo-random number sequence from each of two pseudo-random number generators as secure transaction codes, transmitting the secure transaction codes to a card reader for validating said secure transaction card, generating, encrypting and transmitting control signals or other information corresponding to a function comprising at least one of personal identity data, passport data, equipment control signals, an entry request to a secure area, medical records or access data therefor, note pad access data and secure telephone entry data.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic illustration of the basic components of a secure transaction card in accordance with the invention,

FIG. 2 is a plan view of an exemplary operating surface configuration of a secure transaction card in accordance with the invention,

FIG. 3 is a schematic depiction of a system including a card reader in accordance with the invention, and

FIGS. 4 and 5 are a flow chart illustrating operation of an exemplary embodiment of the invention.

### DETAILED DESCRIPTION OF A PREFERRED EMBODIMENT OF THE INVENTION

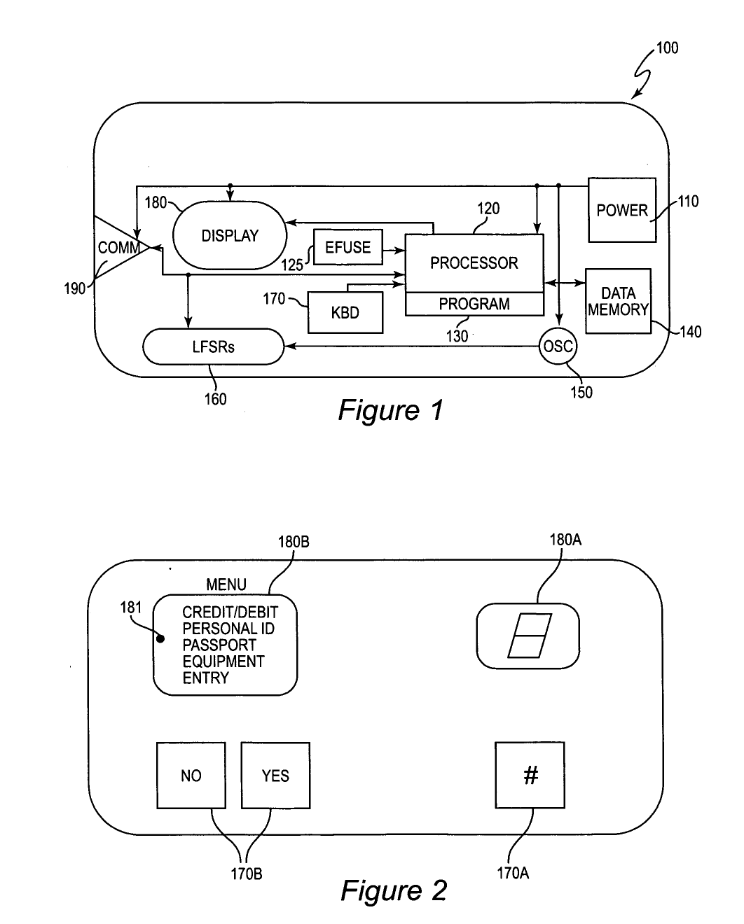

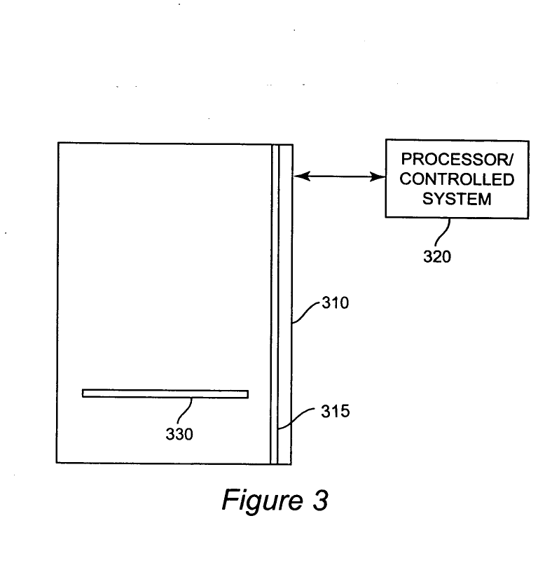

Referring now to the drawings, and more particularly to FIG. 1, there is shown, in high level schematic form, the basic components of a secure, multi-function transaction card 100 in accordance with the invention. It should be noted that, with some modifications, the depiction of FIG. 1 is substantially similar to FIG. 5 illustrating the basic elements of the secure credit card of the above-incorporated patent. The secure transaction card of the present invention includes a power source 110, processor 120, e-fuse or other non-volatile memory 125, oscillator 150, a pair of linear feedback shift registers 160, keyboard 170, display 180 and communications port 190 in common with the secure credit card of the above-incorporated patent although the keyboard 170, display 180 and communication port 190 are preferably modified somewhat therefrom and a data memory 140 of substantial capacity is preferably provided as will be discussed below, particularly in connection with FIG. 2. Further, the secure transaction card in accordance with the invention also includes a preferably expanded program store 130 and may include some additional structures such as contact stripes 115 which may provide enhanced reliability of power availability or other modifications to facilitate transactions of types other than those of a credit/debit card while preferably remaining compatible therewith.

It may be useful to an understanding of the present invention to summarize the constitution and operation of the secure credit card disclosed in the above-incorporated U.S. Pat. No. 6,641,050. A smart card credit card as disclosed in this U.S. patent incorporates integrated electronics within it so that basic processing of information and transmission of information to and from the card may occur. In addition, this secure credit card also uses two linear feedback shift registers (LFSR) respectively referred to as a reference LFSR and a secure LFSR. These LFSRs are synchronized by common free running clock oscillator. The secure LFSR is customized to a unique configuration for each secure credit card. This combination of LFSRs is the key to generating a pseudo random binary string that is used to encrypt information. The generated binary string is a very large sequence sufficient for effective randomness. It is the state of the LFSRs, i.e., the binary sequences generated from the LFSRs and the card ID, that is transmitted to the issuing financial institution during a transaction whereby the institution can validate the authenticity of the card and the transaction. It is the configuration of the secure LFSR that gives the special uniqueness to each secure credit card. This configuration is very difficult and perhaps impossible for thieves to replicate as it cannot be read from the card itself. None of the memory configurations can be read or obtained from outside the secure card.

Unique LFSR configurations are accomplished by employing e-fuse technology within the card. E-fuse technology permits special memory arrangements to be created when the card is manufactured or when the card is issued. E-fuse technology uses writeable integrated fuses that can be “burned” after the card is assembled which in turn provides the unique configurations of the LFSRs and the card ID. There is a personalized identification number (PIN number) also burned into the card which the holder/user must enter to activate the secure card during each transaction.

The institution that issues the card must maintain a record of every card configuration. Whenever a secure credit card is involved in a transaction, the card ID permits the financial institution to retrieve the configuration data for the secure card involved in the transaction. From this configuration information, and the pseudo random number string returned from the secure credit card at the time of the transaction, the card and transaction can be authenticated.

When a holder (so-called since the issuing institution may retain ownership of the card) of the secure credit card wants to use the secure card, a PIN number must be entered directly into the card. If the PIN matches a PIN burned on the card, the secure credit card is activated and a pseudo random sequence is generated which is communicated to the financial institution authenticating the transaction. It is the nature of this combination of features of the secure credit card that makes it unlikely that two transactions of a secure card will have the same pseudo random number sequences communicated outside the card.

Essentially, the transaction card in accordance with the invention can be used for most control applications in much the same way as commonly known access cards. From the standpoint of a holder of the card, the principal operational difference in handling the card is that a holder must activate the card by entry of a PIN to authenticate the holder to the card, after which the card will be active only for a limited period of time sufficient to complete the transaction which may only involve moving the card to a location from which the complex secure transaction codes may be communicated in order to authenticate the card and, since the holder has been authenticated by the card, the holder, as well. Nevertheless, the generation of uniquely encrypted secure codes which will not normally be repeated, together with provision for rejection of secure transaction codes used in a previous transaction while protecting information stored in the card provides an extremely high level of security and a very high confidence level in authentication of both the card and the identity of its holder.

Referring now to FIG. 2, an exemplary layout of the operating surface of the secure transaction card in accordance with the invention is illustrated. The keyboard 170 of FIG. 1 is preferably divided, at least functionally into two portions for convenience of use. Essentially, only two types of information are necessary to operation of of the secure transaction card of the invention in accordance with its most basic principles: the PIN of the holder to activate the card and selection of the function to be performed. The keyboard 170 and display 180 are thus preferably divided in accordance with these types of information to be input to the card for each use. However, it should be understood that the keyboard and display configuration illustrated is merely preferred as a matter of convenience of use and economy of manufacture and has no effect whatsoever on the operation of the card or systems with which it may be employed and that many other arrangements can be employed without departing from the invention.

For the purpose of inputting a PIN in order to activate the secure transaction card, it is preferred to use a single key 170A, preferably of the body contact, capacitive or membrane type which may be manufactured in a very thin structure with no frictionally engaged parts, in connection with a single digit display 180A, preferably of the liquid crystal type for low power consumption and relatively small viewing angle. Under control of processor 120, single digits from 0 to 9 are sequentially displayed, preferably in a random order at a repetition rate of approximately one second per digit. when a digit is displayed which corresponds to a digit of the PIN, in order (e.g. left to right) the operator may press key 170A to capture a digit of the PIN and the process repeated until the PIN is complete. The random presentation of digits presents a worst case PIN entry time of forty seconds but should average only twenty seconds or less. The random order of presentation of digits prevents an observer from discovering the PIN from the timing of actuation of key 170A if, in fact, the slight required motion is even observable while the relatively narrow viewing angle prevents the digits of the PIN from being observed or at least facilitates concealment from the view of persons other than the holder. The complete PIN is preferably never displayed. The single key also prevents the PIN from being discovered by observing hand or finger motion as would be possible if plural keys were employed.

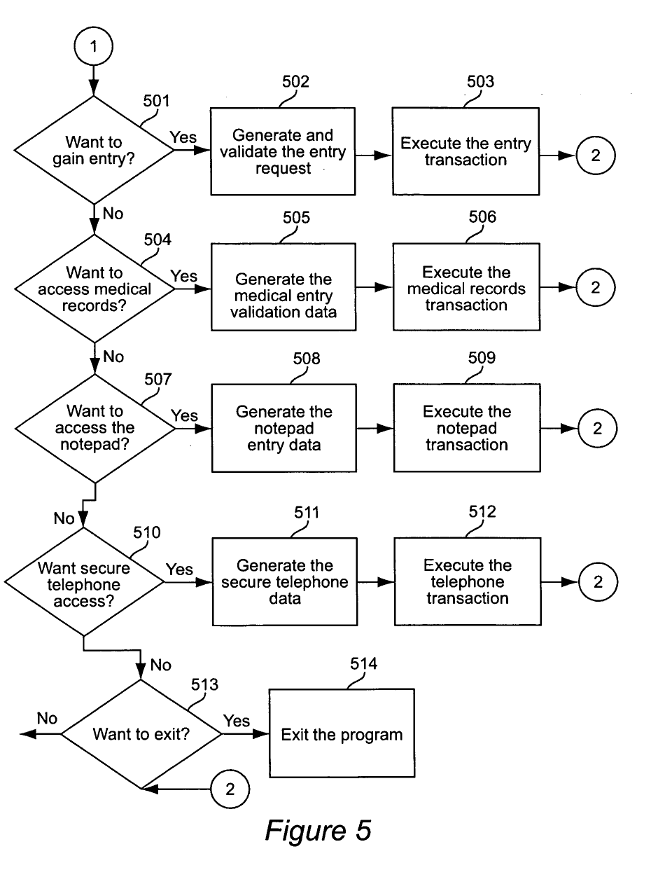

As will be evident from the discussion of FIGS. 4 and 5 below, keyboard portion 170B and display 180B need only accommodate manipulation of a menu-like presentation of information and selection therefrom. Display 180B need only display an indication of the particular type of transaction desired and may sequentially present options such as “credit/debit”, “personal ID” and the like or a list thereof which may be scrollable, as may be desired in view of the number of types of transactions to be accommodated and a potential selection indicated by a cursor or highlighting as indicated at 181. Two keys 170B are entirely sufficient for manipulation of such a display and entry of a control signal based thereon. For example, the “No” key causes cursor movement, scrolling and/or sequencing through possible choices while the “Yes” key causes selection. Depending on the type of transaction (e.g. for particular control of machinery or data output, other menus nested under some or all of the menu selections can be provided and navigated in the same way. Again, many other types of key and display arrangements can be used in accordance with the invention and the particular arrangement shown should be regarded as merely exemplary although it is preferred for convenience of use and economy of manufacture as well as reliability and structural robustness.

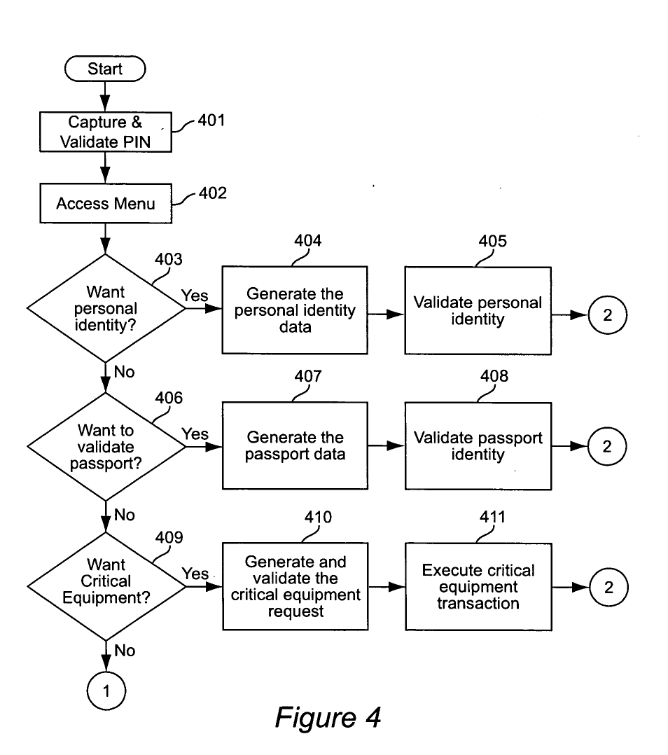

FIG. 3 schematically illustrates a system which cooperates with and is controlled by the transaction card described above comprising a card reader 310 and a processor or controlled system 320. The card reader preferably includes an open-ended slot 315 which can be used to read conventional cards as well as transaction cards in accordance with the invention if the communication port structure 190 (FIG. 1) is placed at the edge of the card, particularly if the secure transaction codes are sufficiently short to be exchanged between the card and reader while the card is moved through the slot. Power can be supplied to the card at the same time to, for example, charge a capacitor sufficiently to complete the processing for some transactions. The card reader is also or alternatively preferably provided with a slot 330 which is closed at the ends and essentially provides a docking socket for the transaction card. Such a slot configuration is preferred for transactions which maqy require more extended secure transaction codes to be exchanged, unidirectionally or bidirectionally. Such a configuration also provides for supplying power to the card on even providing charge to a battery contained therein during extended transactions, for example, downloading of personal identification or medical data or accessing remote files such as for passport validation. Authentication processing made be performed in whole or in part in any of the card, the card reader 310 and/or the processor/controlled system.

Referring now to FIGS. 4 and 5, the preferred mode of operation of the invention will now be explained. The basic architecture of the operation is preferably a chain of branching statements which correspond to the sequence of the menu discussed above in regard to display 180B (FIG. 2). Each branch corresponds to a particular application of the transaction card in accordance with the invention and each branch completes with a choice to exit or not. Separate branches for each type of application or type of transaction (collectively referred to as secure control functions which control apparatus or the communication of information stored in the card; which terminology is intended to exclude credit/debit card functions in making such a collective reference) are considered to be desirable in order to accommodate different control signals and signalling protocols which may exist in equipment already in service. It is considered preferable to prompt the holder for an exit option to ensure that the transaction card is not activated longer than required to carry out the desired transaction(s) even though the activation of the card is only maintained for a short period. In this regard, it is also desirable that the period of activation be separately set for some if not all transaction branches to minimize activation time and return the card to a deactivated condition as soon as possible, particularly to avoid an unauthorized use while still in the active state from a previous authorized transaction.

The operation of the invention begins with the capture and authentication of the holder's PIN, as discussed above, in order to activate the card and authenticate the holder to the card. The menu is then accessed 402 to query the holder for the type of transaction to be performed. In this regard, it is considered to be within the scope of the invention for the secure transaction card to be dedicated to a single control function or a single control function in addition to credit/debit card functions. In the former case, no menu would be required and in the latter, a simple indication such as a blinking indicia would suffice to indicate the chosen function.) It should be noted in this regard that the access to the menu can be a prompt for a menu display and, if not selected, provide for the operation to default to a credit/debit mode of operation as discussed in the above-incorporated U.S. patent. Alternatively, a credit/debit card transaction can be presented in the menu in the same manner as any other branch. It should also be appreciated that more, fewer and/or different types of transactions can be provided in the menu and the order of presentation is irrelevant to the principles of operation of the invention.

If the menu is accessed, the first branch 403 provides a prompt to ask if a personal ID transaction is desired. The “Yes” and “No” branches correspond to sequential actuations of the “Yes” and “No” keys 170B. If so, the personal identification data is read 404 from memory 140 and downloaded through reader 310 to validate 405 the personal ID of the holder. If not the operation proceeds to provide a prompt (or cursor movement to another menu item, scrolling of the menu or the like) for validation of a passport. If selected, passport data is read 407 from memory 140 and downloaded to validate 408 a passport document. In this regard, the passport may also have a processor included for purposes of security in the same manner as the secure credit card of the above-incorporated U.S. patent. Again, a branch separate from the personal ID branch (403-405) is desirable since different data are generally involved which must be separately accessed from memory 140. If the passport validation transaction is not selected, a prompt is issued 409 for control of critical equipment. If selected, a request for particular control is generated and issued 410 and executed 411. In this regard, different control actions (e.g. gaining access to an automobile and starting the automobile or controlling the taking of measurements or the like) can be exercised through one or more nested menus and timing can be closely controlled using switches 170A and/or 170B. If the control of critical equipment is not selected, the process prompts 501 the holder for an entry authorization transaction. If selected, the entry is validated 502 and apparatus such as a lock is actuated 503 to allow entry to the card holder. Other actions can be taken such as logging entry and exit, tracking movements of the card holder by RFID techniques and the like.

If an entry authorization transaction is not selected, a prompt is issued 504 for a medical records transaction. Provision for a medical records transaction is considered to be an important function of the multiple use transaction card in accordance with the invention. Substantial amounts of time are consumed and errors often introduced during appointments with medical personnel in interviewing the patient to obtain medical history information. Substantial time and costs and susceptibility to errors are also involved in the handling of paper files as well as protecting such records from unauthorized access or corruption. Providing access to such information through the transaction card in accordance with the invention allows the holder to personally control access thereto while, when access is authorized, a complete medical history can be made immediately available to medical personnel by reading and downloading 506 data from memory 140. Alternatively, the transaction card can provide access authorization for obtaining medical or other records from another source or database. Further, the card holder may personally supervise updating of medical information during the same session and activation of the card. For this reason and in support of this function, a longer activation time of possibly one-half hour or more may be particularly desirable for this transaction. Using this option of the secure transaction card validates the data retrieved from storage 140 as well as additional data which may be entered as well as authenticating and validating 505 the association of the holder with the information.

If the medical records transaction is not selected, the holder is prompted 507 for notepad access. This transaction is similar to the critical equipment control branch 409-411 where the “equipment” may be a palm-top or laptop computer or the like. If selected, the transaction card validates 508 itself and the holder to the computer or data storage device to allow viewing of stored data and storage of additional data 509 which is maintained at a high level of security if the computer or storage is only accessible through the use of a secure transaction card in accordance with the invention.

If the notepad access is not selected, the holder is prompted for secure telephone access. If selected, the card issues 511 a secure code to control 512 secure functions of a cell phone, PDA, virtual private network or the like for the purpose of making connections, encrypting the communication, if desired, controlling billing and the like.

Additional branches for additional functions can be provided if desired. Further, it should be understood that some devices may be controlled in accordance with branches other than the branches suggested above. For example, the entry authorization branch could be used for access to an office, home or automobile and, for the automobile, could also provide control of starting or other function such as control of windows. Similarly, the control of critical equipment branch could include entry/access authorization, and so on.

In view of the foregoing, it is seen that the multiple use secure transaction card in accordance with the invention provides secure authentication of a holder and the card itself for a wide variety of control functions.

While the invention has been described in terms of a single preferred embodiment, those skilled in the art will recognize that the invention can be practiced with modification within the spirit and scope of the appended claims.

What is claimed is:

1. A secure transaction card comprising
a card body including a processor and associated storage for a stored program for operation of said processor, a communication interface, and a data entry means,
a non-volatile memory for storage of identification information for said secure transaction card and a personal identification number (PIN) of a holder of said secure transaction card, and
encryption means for encoding transaction information and secure control codes corresponding to a secure control function or communication of information from said secure transaction card in accordance with a protocol corresponding to said secure control function in accordance with signals stored in said non-volatile memory.

2. A secure transaction card as recited in claim 1, wherein said non-volatile memory includes signals for performing at least one secure transaction in addition to said secure control function and said secure transaction card further includes means to select between said secure control function and said at least one secure transaction.

3. A secure transaction card as recited in claim 2 wherein said at least one further secure transaction is a credit/debit transaction.

4. A secure transaction card as recited in claim 2 wherein said means to select between said secure control function and said at least one secure transaction includes a menu.

5. A secure transaction card as recited in claim 4 wherein said non-volatile memory further stores signals for performing a secure credit/debit transaction.

6. A secure transaction card as recited in claim 1, wherein said secure control function controls communication of personal identity information.

7. A secure transaction card as recited in claim 1, wherein said secure control function provides validation of a passport.

8. A secure transaction card as recited in claim 1, wherein said secure control function provides control of equipment.

9. A secure transaction card as recited in claim 1, wherein said secure control function authorizes entry into a secure area.

10. A secure transaction card as recited in claim 1, wherein said secure control function provides access to medical information.

11. A secure transaction card as recited in claim 1, wherein said secure control function provides access to an electronic notepad.

12. A secure transaction card as recited in claim 1, wherein said secure control function communicates personal identity.

13. A secure transaction card as recited in claim 2, wherein said secure control function controls communication of personal identity information.

14. A secure transaction card as recited in claim 2, wherein said secure control function provides validation of a passport.

15. A secure transaction card as recited in claim 2, wherein said secure control function provides control of equipment.

16. A secure transaction card as recited in claim 2, wherein said secure control function authorizes entry into a secure area.

17. A secure transaction card as recited in claim 2, wherein said secure control function provides access to medical information.

18. A secure transaction card as recited in claim 2, wherein said secure control function provides access to an electronic notepad.

19. A secure transaction card as recited in claim 2, wherein said secure control function communicates personal identity.

20. A method of performing a secure control function using a secure transaction card, said method comprising steps of
authenticating a user of the secure tranaction card using a PIN,
generating a pseudo-random number sequence from each of two pseudo-random number generators as secure transaction codes,
transmitting said secure transaction codes to a card reader for validating said secure transaction card,
generating, encrypting and transmitting control signals or other information corresponding to a function comprising at least one of personal identity data, passport data, equipment control signals, an entry request to a secure area, medical records or access data therefor, note pad access data and secure telephone entry data.

21. A method as recited in claim 21, wherein said step of generating, encrypting and transmitting control signals or other information further includes signals corresponding to a credit/debit card transaction.

22. A method as recited in claim 20, further including a step of storing said control signals or other information corresponding to a function comprising at least one of personal identity data, passport data, equipment control signals, an entry request to a secure area, medical records or access data therefor, note pad access data and secure telephone entry data and
selecting one of said control signals or other information for retrieval, encryption and transmission.

23. A method as recited in claim 22 wherein said selecting step is performed using a menu.
